(19) United States
(12) Patent Application Publication
(10) Pub. No.: US 2017/0029605 A1
(43) Pub. Date: Feb. 2, 2017

(54) RUBBER COMPOSITION FOR TIRE AND PNEUMATIC TIRE

(71) Applicant: TOYO TIRE & RUBBER CO., LTD., Osaka (JP)

(72) Inventor: Yuuki Masumoto, Osaka-shi (JP)

(73) Assignee: TOYO TIRE & RUBBER CO., LTD., Osaka (JP)

(21) Appl. No.: 15/216,028

(22) Filed: Jul. 21, 2016

(30) Foreign Application Priority Data
Jul. 27, 2015 (JP) 2015-147924
May 16, 2016 (JP) 2016-098081

(51) Int. Cl. C08L 9/06; B60C 1/00

(52) U.S. Cl. CPC C08L 9/06; B60C 1/0025; B60C 1/0016; B60C 2001/005

(57) ABSTRACT

A rubber composition for a tire comprises a diene rubber, a petroleum-derived wax and a fatty acid metal salt, wherein the difference (Δ=Cmw−Cmf) obtained by subtracting the carbon number (Cmf) of a constituent fatty acid contained the most in the fatty acid metal salt from the carbon number (Cmw) of a hydrocarbon contained the most in the petroleum-derived wax is −10 or more and 8 or less. The rubber composition can suppress whitening of a rubber surface while maintaining ozone resistance. A pneumatic tire has a rubber part comprising the rubber composition, wherein the rubber part is at least one selected from the group consisting of a tread rubber, a side wall rubber, and a rim strip.

### CROSS-REFERENCE TO RELATED APPLICATIONS

This application is based upon and claims the benefit of priority from the prior Japanese Patent Application Nos. 2015-147924, filed on Jul. 27, 2015 and 2016-98081, filed on May 16, 2016; the entire contents of all of which are incorporated herein by reference.

### BACKGROUND

1. Technical Field

The present invention relates to a rubber composition for a tire and a pneumatic tire using the rubber composition

2. Related Art

A rubber composition forming a tread rubber, side wall rubber and rim strip of a pneumatic tire contains a wax in order to suppress deterioration by ozone and ultraviolet rays in the air. Wax has a deterioration suppressing effect such as ozone resistance, and on the other hand, whitens a rubber surface by blooming on the rubber surface, becoming a factor of poor appearance of a tire. For this reason, the rubber composition is required to suppress whitening while maintaining ozone resistance.

To suppress whitening by a wax, JP-A-2015-017273 discloses to add a natural wax having a low softening point component and a polar natural wax having a high softening point component to a rubber composition containing a polar rubber, silica and carbon black. To neutralize an acid contained in an epoxidized natural rubber as a polar rubber, this patent document further discloses to add an alkaline fatty acid metal salt such as calcium stearate. However, this patent document denies the use of a petroleum-derived wax, and does not disclose to adjust the carbon number of a petroleum-derived wax and the carbon number of a fatty acid metal salt.

JP-A-2014-210830 discloses to add a fatty acid metal salt having the carbon number from 16 to 20 smaller than the carbon number of a hydrocarbon contained the most in a wax, together with a petroleum-derived wax such as a paraffin type wax. However, according to the investigations by the present inventors, it was ascertained that when the difference in the carbon number between the fatty acid metal salt and the wax is large as above, the effect of suppressing whitening is not sufficiently obtained.

JP-A-2011-246640 discloses to add a mixture of a fatty acid metal salt and a fatty acid ester, and a wax in a rubber composition for a tire tread. JP-A-2013-018868 discloses to add a wax together with zinc stearate as a mold releasing agent in a rubber composition for a side wall. Furthermore, JP-A-2011-140612 discloses to add a fatty acid metal salt and a wax in a rubber composition for a tire used in a tread, a side wall or the like. However, those patent documents do not suggest that whitening can be suppressed by adjusting the carbon number of a wax and the carbon number of a fatty acid metal salt.

### SUMMARY

In view of the above, an object of the present embodiment is to provide a rubber composition that can suppress whitening of a rubber surface while maintaining ozone resistance.

A rubber composition for a tire according to the present embodiment comprises a diene rubber, a petroleum-derived wax, and a fatty acid metal salt, wherein the difference obtained by subtracting the carbon number (Cmf) of a constituent fatty acid contained the most in the fatty acid metal salt from the carbon number (Cmw) of a hydrocarbon contained the most in the petroleum-derived wax, (Δ=Cmw−Cmf), is −10 or more and 8 or less.

A pneumatic tire according to the present embodiment has a rubber part comprising the rubber composition, wherein the rubber part is at least one selected from the group consisting of a tread rubber, a side wall rubber and a rim strip.

Thus, by adding a petroleum-derived wax and a fatty acid metal salt having a specific carbon number relationship with the petroleum-derived wax, whitening of a rubber surface can be suppressed while maintaining ozone resistance.

### BRIEF DESCRIPTION OF THE DRAWING

FIG. 1 is a half cross-sectional view showing one example of a pneumatic tire.

### DETAILED DESCRIPTION

Elements for carrying out the present embodiment are described in detail below.

The rubber composition according to the present embodiment comprises (A) a diene rubber, (B) a petroleum-derived wax, and (C) a fatty acid metal salt.

### (A) Diene Rubber

Diene rubber as a rubber component is not particularly limited. Examples of the diene rubber that can be used include natural rubber (NR), isoprene rubber (IR), butadiene rubber (BR), styrene-butadiene rubber (SBR), styrene-isoprene rubber, butadiene-isoprene rubber, styrene-butadiene-isoprene rubber and nitrile rubber (NBR). Those diene rubbers can be used alone or as mixtures of two or more thereof. More preferred diene rubber is at least one selected from the group consisting of natural rubber, isoprene rubber, styrene-butadiene rubber and butadiene rubber.

As one embodiment, the diene rubber of a rubber composition for a tread may be SBR alone, a blend of SBR and BR, NR alone or a blend of NR and BR. Furthermore, as one embodiment, the diene rubber of a rubber composition for a side wall and for a rim strip may be NR alone or a mixture of NR and BR.

### (B) Petroleum-Derived Wax

The petroleum-derived wax is called a petroleum wax and is a hydrocarbon type wax obtained from petroleum. By adding the petroleum-derived wax, the wax blooms on a rubber surface, thereby ozone resistance is given to the rubber surface. On the other hand, a wax becomes a factor of whitening. However, when the petroleum-derived wax is used as a wax, whitening can be suppressed by further using a specific fatty acid metal salt described hereinafter. When a wax other than the petroleum-derived wax has been used, ozone resistance is insufficient, and a whitening suppression effect when used together with the specific fatty acid metal salt is insufficient.

Examples of the petroleum-derived wax include a paraffin wax and/or a microcrystalline wax. The paraffin wax is a solid wax at room temperature, separated and extracted from a distillate part by vacuum distillation of a crude oil, and is a saturated hydrocarbon mainly comprising a linear saturated hydrocarbon (normal paraffin). The microcrystalline wax is a solid wax at room temperature, separated and extracted mainly from a residue oil part or heavy distillate part by vacuum distillation of a crude oil, and is a hydrocarbon containing large amounts of a branched saturated hydrocarbon (isoparaffin) and a saturated cyclic hydrocarbon (cycloparaffin). In one embodiment, it is preferred that the petroleum-derived wax is a paraffin type petroleum wax. The paraffin type petroleum wax used herein means a wax containing a paraffin wax, and is preferably a paraffin wax or a mixture of a paraffin wax and a microcrystalline wax.

The petroleum-derived wax is generally a mixture containing hydrocarbons having the carbon number in a range of from 20 to 60, and the petroleum-derived wax having a peak in a carbon number distribution of the hydrocarbons may be used. The carbon number of the hydrocarbons contained in the petroleum-derived wax is not particularly limited. For example, the carbon number (Cmw) of a hydrocarbon contained the most in the petroleum-derived wax may be from 20 to 50, may be from 20 to 40, may be from 20 to 35, may be from 20 to 30, and may be from 22 to 28. The “carbon number of a hydrocarbon contained the most in the petroleum-derived wax” is the carbon number of the hydrocarbon having the largest mass ratio in the hydrocarbons contained in the petroleum-derived wax. The Cmw can be obtained from, for example, a peak top of a carbon number distribution measured using gas chromatography.

The amount of petroleum-derived wax added is not particularly limited. For example, the amount may be from 0.1 to 10 parts by mass, may be from 0.5 to 5 parts by mass, and may be from 1 to 3 parts by mass, per 100 parts by mass of the diene rubber from the standpoint of ozone resistance and the like.

### (C) Fatty Acid Metal Salt

The rubber composition according to the present embodiment contains a fatty acid metal salt together with the petroleum-derived wax. The fatty acid metal salt may be a mixture of a plurality of fatty acid metal salts. It is considered that the addition of the fatty acid metal salt inhibits the crystallization of the petroleum-derived wax bloomed on a rubber surface, the wax forms a smooth film, and this makes difficult to cause whitening.

In the present embodiment, the fatty acid metal salt satisfying the following requirements is used. That is, when the carbon number of the hydrocarbon contained the most in the petroleum-derived wax is Cmw and the carbon number of the constituent fatty acid contained the most in the fatty acid metal salt is Cmf, the difference Δ (=Cmw−Cmf) by subtracting Cmf from Cmw is −10 or more and 8 or less (−10≦Δ≦8). Thus, it is considered that a bloom film of the petroleum-derived wax formed on a rubber surface can be further uniformly thin by using the fatty acid metal salt in which the constituent fatty acid having the same degree of the carbon number as the carbon number of the petroleum-derived wax is a main component. As a result, whitening is difficult to cause and good appearance can be obtained. When Δ is larger than 8, the difference of the carbon number between the fatty acid metal salt and the petroleum-derived wax is large, and the effect of suppressing whitening is not sufficiently obtained. On the other hand, when A is smaller than −10, the carbon number of the fatty acid metal salt to the carbon number of the petroleum-derived wax is too large, and the effect of suppressing whitening is insufficient. The difference Δ is preferably from −5 to 6, more preferably from −3 to 6, and may be from −1 to 5.

The “constituent fatty acid” used herein means fatty acid constituting the fatty acid metal salt. The “carbon number (Cmf) of the constituent fatty acid contained the most in the fatty acid metal salt” used herein means the carbon number of fatty acid having the largest molar ratio in fatty acids constituting the fatty acid metal salt. The fatty acid constituting the fatty acid metal salt generally comprises single fatty acid or a plurality of fatty acids having different carbon number. In the case of the fatty acid metal salt in which the constituent fatty acid is only one kind, the carbon number (Cmf) of the constituent fatty acid contained the most in the fatty acid metal salt is the carbon number of the one kind of the constituent fatty acid. In the case where the fatty acid metal salt is a mixture of a plurality of fatty acid metal salts, Cmf is the carbon number of the fatty acid having the largest molar ratio in all of fatty acids constituting a plurality of fatty acid metal salts. Cmf is obtained by, for example, converting a fatty acid metal salt into a fatty acid ester by reactive pyrolysis by tetramethylammonium hydroxide, and obtaining the fatty acid having the largest molar ratio from the content ratio of each fatty acid obtained by analyzing with gas chromatograph mass spectrometer (GC/MS).

It is preferred that the carbon number (Cmf) of the constituent fatty acid contained the most in the fatty acid metal salt is larger than 18. This embodiment can increase whitening suppression effect. The Cmf is preferably larger than 20, and more preferably 22 or more. The upper limit of the Cmf is not particularly limited, but may be 30 or less.

Examples of the fatty acid (constituent fatty acid) constituting the fatty acid metal salt include various saturated fatty acids and/or unsaturated fatty acids, having the carbon number in which the difference Δ in the carbon number between those fatty acids and the hydrocarbon contained the most in a petroleum-derived wax is from −10 to 8. Specific examples of the constituent fatty acid include myristic acid (carbon number: 14), pentadecanoic acid (carbon number: 15), palmitic acid (carbon number: 16), heptadecanoic acid (carbon number: 17), stearic acid (carbon number: 18), arachidic acid (carbon number: 20), behenic acid (carbon number: 22), lignoceric acid (carbon number: 24), cerotic acid (carbon number: 26), montanoic acid (carbon number: 28) and melissic acid (carbon number: 30). Those can be used in any one kind or as mixtures of two or more kinds thereof. Fatty acid having the carbon number smaller than that of those fatty acids and/or fatty acid having the carbon number larger than that of those fatty acids may be contained as the constituent fatty acid so long as it satisfies the above requirement of the difference Δ.

Examples of the metal salt in the fatty acid metal salt include an alkali metal salt such as a sodium salt (Na) or a potassium salt (K), an alkaline earth metal salt such as a magnesium salt (Mg) or a calcium salt (Ca), and a transition metal salt such as a zinc salt (Zn), a cobalt salt (Co) or a copper salt (Cu). Of those, an alkali metal salt and/or an alkaline earth metal salt are preferred, and a sodium salt and/or a calcium salt are more preferred.

The amount of the fatty acid metal salt added is not particularly limited. From the standpoint of enhancing the effect of suppressing whitening by the petroleum-derived wax, the amount is preferably from 0.5 to 10 parts by mass, more preferably from 1 to 8 parts by mass, and may be from 2 to 5 parts by mass, per 100 parts by mass of the diene rubber.

### (D) Other Components

The rubber composition according to the present embodiment can further contain various additives generally used in a rubber composition, such as a filler, an age resister, zinc flower, stearic acid, a process oil, a vulcanizing agent or a vulcanization accelerator, in addition to the above-described components.

Carbon black and/or silica can be added as the filler. The carbon black is not particularly limited, and can use various grades of furnace carbon blacks, such as SAF grade (N100 Series), ISAF grade (N200 Series), HAF grade (N300 Series) and FEF grade (N500 Series) (those are ASTM grade), that are used as a reinforcing agent for a rubber. The silica is not particularly limited, but wet silica (hydrated silicic acid) is preferred. The amount of the filler added is not particularly limited, but is preferably from 10 to 150 parts by mass, more preferably from 20 to 120 parts by mass, and still more preferably from 30 to 100 parts by mass, per 100 parts by mass of the diene rubber. As one embodiment, the amount of the carbon black added may be from 10 to 120 parts by mass, and may be from 20 to 100 parts by mass, per 100 parts by mass of the diene rubber. The amount of the silica added may be from 10 to 120 parts by mass, and may be from 20 to 100 parts by mass, per 100 parts by mass of the diene rubber.

When silica is added as the filler, a silane coupling agent such as sulfide silane or mercaptosilane may be added in order to further improve dispersibility of silica. The amount of the silane coupling agent added is not particularly limited, but is preferably from 2 to 20 mass % based on the amount of silica added.

Examples of the vulcanizing agent include sulfurs such as powdered sulfur, precipitated sulfur, colloidal sulfur, insoluble sulfur and highly dispersible sulfur. The amount of the vulcanizing agent added is not particularly limited, but may be from 0.1 to 10 parts by mass, and may be from 0.5 to 5 parts by mass, per 100 parts by mass of the diene rubber.

The rubber composition according to the present embodiment can be prepared by kneading the necessary components according to the conventional method using a mixing machine generally used, such as Banbury mixer, a kneader or rolls. Specifically, other additives excluding a vulcanizing agent and a vulcanization accelerator are added to a diene rubber together with a petroleum-derived wax and a fatty acid metal salt, followed by mixing, in a first mixing step. A vulcanizing agent and a vulcanization accelerator were then added to the mixture thus obtained, followed by mixing, in a final mixing step. Thus, a rubber composition can be prepared.

The rubber composition thus obtained can be used in pneumatic tires of various uses and sizes, such as tires for passenger cars and heavy load tires for trucks or buses. The rubber composition is preferably used in at least one selected from the group consisting of a tread rubber, a side wall rubber, and a rim stripe of a pneumatic tire.

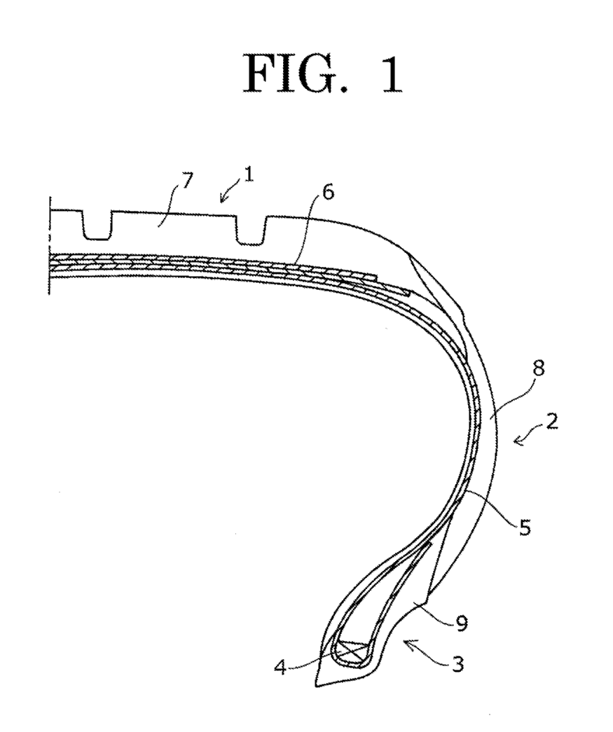

FIG. 1 is a view showing one example of a pneumatic tire. The pneumatic tire comprises a tread part 1, a pair of right and left side wall parts 2 extending inside in a radial direction from both edges of the tread part, and a pair of right and left bead parts 3 provided inside in a radial direction of the side wall parts 2. A carcass ply 5 toroidally extending between a pair of bead cores 4 embedded in a pair of bead parts 3 is embedded in the pneumatic tire. A belt 6 is provided at the outer circumferential side in a radial direction of the carcass ply 5 in the tread part 1.

The pneumatic tire further comprises a tread rubber 7 provided at an outer circumferential side in a radial direction of the belt 6 in the tread part 1 and forming a ground contact surface, a side wall rubber 8 provided at a tire outer surface side of the carcass ply 5 in the side wall part 2 and forming a tire outer surface of the side wall part 2, and a rim strip 9 provided so as to cover a region in contact with a rim flange in the bead part 3 and forming a tire outer surface of the bead part 3. The rim strip 9 is a rubber layer provided outside the bead part 3 in continuation with a lower edge of the side wall rubber 8.

Those tread rubber 7, side wall rubber 8 and rim strip 9 form an outer surface of a pneumatic tire, and are therefore required to suppress discoloration of a rubber surface. For this reason, the rubber composition according to the present invention is preferably used.

The pneumatic tire can be manufactured according to the conventional method using the rubber composition according to the present embodiment. For example, an unvulcanized tread rubber member, a side wall rubber member and/or a rim strip rubber member are obtained by molding the rubber composition into a given shape by extrusion processing. Those members are combined with other parts, thereby manufacturing a green tire. The green tire obtained is vulcanization-molded at a temperature of; for example, from 140 to 180° C., thereby a pneumatic tire can be manufactured. The pneumatic tire according to the present embodiment is that at least one of a tread rubber, a side wall rubber or a rim strip is formed by the rubber composition according to the present embodiment

### Examples

Examples of the present embodiment are described below, but the present invention is not construed as being limited to those examples.

### First Example

Banbury mixer was used. Compounding ingredients other than sulfur and a vulcanization accelerator were added to and kneaded with a diene rubber according to the formulations (parts by mass) shown in Table 1 below in a first mixing step (discharge temperature: 160° C.). Sulfur and a vulcanization accelerator were added to and kneaded with the kneaded material obtained above in a final mixing step (discharge temperature: 90° C.). Thus, a rubber composition was prepared. The details of each component in Table 1 are as follows.

SBR: Styrene-butadiene rubber, “SBR1723” manufactured by JSR Corporation

BR: Butadiene rubber, “BR 150” manufactured by Ube Industries, Ltd.

Carbon black 1: HAF, “SEAST 3” manufactured by Tokai Carbon Co., Ltd.

Silica: “NIPSIL AQ” manufactured by Tosoh Silica Corporation

Oil: “JOMO PROCESS NC140” manufactured by JX Nippon Oil & Sun-Energy Corporation

Silane coupling agent: “Si75” manufactured by Evonik

Zinc flower: “Zinc Flower #1” manufactured by Mitsui Mining & Smelting Co., Ltd.

Stearic acid: “LUNAC S-20” manufactured by Kao Corporation

Age resister 1: “ANTIGEN 6C” manufactured by Sumitomo Chemical Co., Ltd.

Sulfur: “5% Oil-Treated Powdered Sulfur” manufactured by Tsurumi Chemical Industry Co., Ltd.

Vulcanization accelerator CZ: “SOXINOL CZ” manufactured by Sumitomo Chemical Co., Ltd.

Vulcanization accelerator D: “SANCELER DM-G” manufactured by Sanshin Chemical Industry Co., Ltd.

Calcium laurate: “CS-3” (Cmf: 12) manufactured by Nitto Kasei. Kogyo K.K.

Zinc laurate: “ZS-3” (Cmf: 12) manufactured by Nitto Kasei Kogyo K.K.

Calcium stearate: “Calcium Stearate G” (Cmf: 18) manufactured by NOF Corporation

Calcium behenate: “CS-7” (Cmf: 22) manufactured by Nitto Kasei Kogyo K.K.

Sodium behenate: “NS-7” (Cmf: 22) manufactured by Nitto Kasei Kogyo K.K.

Calcium montanate: “CS-8” (Cmf: 28) manufactured by Nitto Kasei Kogyo IK.

Wax 1: Petroleum wax (paraffin type petroleum wax), “OZOACE 0355” (Cmw: 27) manufactured by Nippon Seiro Co., Ltd.

Wax 2: Petroleum wax (paraffin type petroleum wax). Trial wax obtained by subjecting various commercially available waxes to column separation using gas chromatography (GC), separation extracting wax components having specific carbon number, and combining and blending those wax components, thereby adjusting the carbon number distribution (Cmw: 32)

Wax 3: Petroleum wax (paraffin type petroleum wax). Trial wax obtained by subjecting various commercially available waxes to column separation using gas chromatography (GC), separation extracting wax components having specific carbon number, and combining and blending those wax components, thereby adjusting the carbon number distribution (Cmw: 23)

Wax 4: Animal type wax, “BEESWAX CO-100” manufactured by Yokozeki Oil & Fat Industries Co., Ltd. (Cmw: 26)

Cmw (carbon number of hydrocarbon contained the most in wax) was obtained as follows. Capillary gas chromatography (GC) was used as a measurement instrument. Carbon number distribution of a wax was obtained by measuring up to 390° C. from 180° C. under the conditions of carrier gas: helium, flow rate: 4 mL/min and temperature rising rate: 15° C./min using a polyimide-coated capillary column, and carbon number of a peak top was obtained from the carbon number distribution.

Cmf (carbon number of constituent fatty acid contained the most in fatty acid metal salt) can be obtained using reactive pyrolysis GCMS (gas chromatography mass spectrometer). In the present embodiment, heating decomposition was conducted at 350° C. using a pyrolyzer (3030D) manufactured by Frontier Laboratories Ltd., and the measurement of pyrolysis GC/MS was conducted using GC/MS device (Automass SUN) manufactured by JEOL Ltd. (column used: VA-DX30 manufactured by Frontier Laboratories Ltd., carrier gas: helium, flow rate: 1 mL/min, temperature rising rate: 10° C./min). In this case, a material obtained by adding 2 L of a 25 mass % tetramethylammonium hydroxide/methanol solution to about 200 μg of a sample was used as a measurement sample.

Each rubber composition was vulcanized at 160° C. for 20 minutes to prepare each test piece, and appearance (whitening) and ozone resistance of each test piece were evaluated. Each evaluation method is as follows.

Appearance (whitening): A vulcanized rubber piece was placed in an oven adjusted to a temperature of 40° C., and was allowed to stand therein for 3 weeks. Thereafter, the surface of the vulcanized rubber piece was visually observed, and appearance (whitening) was evaluated by the following criteria. Appearance is good as the point is large

Point 5: Surface is black, and discoloration is not substantially observed

Point 4: Surface is slightly discolored white

Point 3: Less than half of the whole surface is discolored white

Point 2: Half or more of the whole surface is discolored white

Point 1: Surface is discolored white as a whole

Ozone resistance: A vulcanized rubber piece was arranged in an ozone weather meter under the condition of 25% elongation, and was allowed to stand in the environment of ozone concentration of 100 pphm and a temperature of 50° C. for 24 hours. Thereafter, generation state of cracks was visually observed, and ozone resistance was evaluated by the following criteria. Ozone resistance is good as the point is large.

Point 4: No generation of cracks

Point 3: Not visually confirmed, but cracks that can be confirmed by a magnifying glass of 10 magnifications are generated

Point 2: Cracks of 1 mm or less are generated

Point 1: Cracks exceeding 1 mm are generated

TABLE 1

| | Com. | Com. | Com. | Com. | Com. | Com. | | | | | | |
|---|---|---|---|---|---|---|---|---|---|---|---|---|
| Formulation (parts by mass) | Ex. 1 | Ex. 2 | Ex. 3 | Ex. 4 | Ex. 5 | Ex. 6 | Ex. 1 | Ex. 2 | Ex. 3 | Ex. 4 | Ex. 5 | Ex. 6 |
| SBR | 70 | 70 | 70 | 70 | 70 | 70 | 70 | 70 | 70 | 70 | 70 | 70 |
| BR | 30 | 30 | 30 | 30 | 30 | 30 | 30 | 30 | 30 | 30 | 30 | 30 |
| Carbon black 1 | 35 | 35 | 35 | 35 | 35 | 35 | 35 | 35 | 35 | 35 | 35 | 35 |
| Silica | 35 | 35 | 35 | 35 | 35 | 35 | 35 | 35 | 35 | 35 | 35 | 35 |
| Oil | 20 | 20 | 20 | 20 | 20 | 20 | 20 | 20 | 20 | 20 | 20 | 20 |
| Silane coupling agent | 2.8 | 2.8 | 2.8 | 2.8 | 2.8 | 2.8 | 2.8 | 2.8 | 2.8 | 2.8 | 2.8 | 2.8 |
| Zinc flower | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 |
| Age resister 1 | 2 | 2 | 2 | 2 | 2 | 2 | 2 | 2 | 2 | 2 | 2 | 2 |
| Calcium laurate | | | 3 | | | | | | | | | |
| Zinc laurate | | | | 3 | | | | | | | | |
| Calcium stearate | | | | | 3 | 3 | | | | | | 3 |
| Calcium behenate | | | | | | | 3 | | | | | |
| Sodium behenate | | | | | | | | 3 | | | | |
| Calcium montanate | | | | | | | | | 3 | 3 | 3 | |
| Wax 1 | | 2 | 2 | 2 | 2 | | 2 | 2 | 2 | | | |
| Wax 2 | | | | | | | | | | 2 | | |
| Wax 3 | | | | | | | | | | | 2 | 2 |
| Wax 4 | | | | | | 2 | | | | | | |
| Sulfur | 2 | 2 | 2 | 2 | 2 | 2 | 2 | 2 | 2 | 2 | 2 | 2 |
| Vulcanization accelerator CZ | 2 | 2 | 2 | 2 | 2 | 2 | 2 | 2 | 2 | 2 | 2 | 2 |
| Vulcanization accelerator D | 1 | 1 | 1 | 1 | 1 | 1 | 1 | 1 | 1 | 1 | 1 | 1 |
| Carbon number of hydrocarbon contained | — | 27 | 27 | 27 | 27 | 26 | 27 | 27 | 27 | 32 | 23 | 23 |
| the most in wax (Cmw) | | | | | | | | | | | | |
| Carbon number of constituent fatty acid contained | — | — | 12 | 12 | 18 | 18 | 22 | 22 | 28 | 28 | 28 | 18 |
| the most in fatty acid metal salt (Cmf) | | | | | | | | | | | | |
| Difference Δ (=Cmw − Cmf) | — | — | 15 | 15 | 9 | 8 | 5 | 5 | −1 | 4 | −5 | 5 |
| Evaluation | | | | | | | | | | | | |
| Appearance (whitening) | 5 | 1 | 1 | 1 | 2 | 2 | 5 | 5 | 5 | 5 | 4 | 3 |
| Ozone resistance | 1 | 3 | 3 | 3 | 3 | 2 | 3 | 3 | 3 | 3 | 3 | 3 |

### Second Example

Banbury mixer was used. Rubber compositions were prepared in the same manner as in First Example according to the formulations (parts by mass) shown in Table 2 below. The details of each component in Table 2 are as follows (the details of the same components as shown in Table 1 are the same as described above).

NR: Natural rubber, RSS#3

Carbon black 2: FEF, “SEAST SO” manufactured by Tokai Carbon Co., Ltd.

Age resister 2: “ANTIGEN RD-G” manufactured by Sumitomo Chemical Co., Ltd.

Vulcanization accelerator NS: “NOCCELER NS-P” manufactured by Ouchi Shinko Chemical Industrial Co., Ltd.

Each rubber composition was vulcanized at 160° C. for 20 minutes to prepare each test piece, and appearance (whitening) and ozone resistance of each test piece were evaluated. Each evaluation method is the same as described above.

TABLE 2

| | Com. | Com. | Com. | Com. | Com. | Com. | | | |
|---|---|---|---|---|---|---|---|---|---|
| Formulation (parts by mass) | Ex. 7 | Ex. 8 | Ex. 9 | Ex. 10 | Ex. 11 | Ex. 12 | Ex. 7 | Ex. 8 | Ex. 9 |
| NR | 50 | 50 | 50 | 60 | 50 | 50 | 50 | 50 | 50 |
| BR | 50 | 50 | 50 | 50 | 50 | 50 | 50 | 50 | 50 |
| Carbon black 2 | 50 | 50 | 50 | 50 | 50 | 50 | 50 | 50 | 50 |
| Oil | 10 | 10 | 10 | 10 | 10 | 10 | 10 | 10 | 10 |
| Zinc flower | 3 | 3 | 3 | 3 | 3 | 3 | 3 | 3 | 3 |
| Stearic acid | 2 | 2 | 2 | 2 | 2 | 2 | 2 | 2 | 2 |
| Age resister 1 | 2 | 2 | 2 | 2 | 2 | 2 | 2 | 2 | 2 |
| Age resister 2 | 2 | 2 | 2 | 2 | 2 | 2 | 2 | 2 | 2 |
| Calcium laurate | | | 3 | | | | | | |
| Zinc laurate | | | | 3 | | | | | |
| Calcium stearate | | | | | 3 | 3 | | | |
| Calcium behenate | | | | | | | 3 | | |
| Sodium behenate | | | | | | | | 3 | |
| Calcium montanate | | | | | | | | | 3 |
| Wax 1 | | 2 | 2 | 2 | 2 | | 2 | 2 | 2 |
| Wax 4 | | | | | | 2 | | | |
| Sulfur | 2 | 2 | 2 | 2 | 2 | 2 | 2 | 2 | 2 |
| Vulcanization accelerator NS | 1 | 1 | 1 | 1 | 1 | 1 | 1 | 1 | 1 |
| Carbon number of hydrocarbon contained | — | 27 | 27 | 27 | 27 | 26 | 27 | 27 | 27 |
| the most in wax (Cmw) | | | | | | | | | |
| Carbon number of constituent fatty acid contained | — | — | 12 | 12 | 18 | 18 | 22 | 22 | 28 |
| the most in fatty acid metal salt (Cmf) | | | | | | | | | |
| Difference Δ (=Cmw − Cmf) | — | — | 15 | 15 | 9 | 8 | 5 | 5 | −1 |
| Evaluation | | | | | | | | | |
| Appearance (whitening) | 5 | 1 | 1 | 1 | 2 | 2 | 5 | 5 | 5 |
| Ozone resistance | 1 | 3 | 3 | 3 | 3 | 2 | 3 | 3 | 3 |

As shown in Table 1, in Comparative Example 2 in which the wax was added, ozone resistance was improved as compared with Comparative Example 1 as a control, but the rubber surface was whitened and the appearance was poor. In Comparative Examples 3 and 4, the fatty acid metal salt was added together with the wax, but the difference Δ in the carbon number between the fatty acid metal salt and the wax was large, and the suppressing effect of whitening was not obtained. In Comparative Example 5, slight improvement effect was recognized in the appearance as compared with Comparative Examples 3 and 4 by adding the fatty acid metal salt having higher carbon number. However, the difference Δ in the carbon number between the fatty acid metal salt and the wax was still large, and the improvement effect was insufficient. In Comparative Example 6, the difference Δ in the carbon number between the fatty acid metal salt and the wax was small. However, since the wax used was not a petroleum-derived wax, but was an animal wax, the whitening suppression effect was insufficient, and ozone resistance was also poor.

On the other hand, in Examples 1 to 6 in which the fatty acid metal salt was added together with the petroleum-derived wax and the difference Δ in the carbon number between those was within the specified range, whitening was suppressed and appearance could be improved while maintaining ozone resistance.

Furthermore, similarly to SBR/BR system in Table 1, in NR/BR system in Table 2, by adding the petroleum-derived wax and the fatty acid metal salt and making the difference Δ in the carbon number between those fall within the specified range, whitening was suppressed and appearance could be improved while maintaining ozone resistance.

Table 1 is the formulations for a tread, and Table 2 is the formulations for a side wall. The formulations for a rim strip are that composition and the like of the rubber component as a base are common to those in the formulations for a side wall. Therefore, one skilled in the art would easily understand that the same effects are obtained in the formulations for a rim strip.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rubber composition for a tire, comprising a diene rubber, a petroleum-derived wax and a fatty acid metal salt,
wherein the difference (Δ=Cmw−Cmf) obtained by subtracting the carbon number (Cmf) of a constituent fatty acid contained the most in the fatty acid metal salt from the carbon number (Cmw) of a hydrocarbon contained the most in the petroleum-derived wax is −10 or more and 8 or less.

2. The rubber composition for a tire according to claim 1, wherein the carbon number (Cmf) of a constituent fatty acid contained the most in the fatty acid metal salt is larger than 18.

3. The rubber composition for a tire according to claim 1, wherein the difference (Δ=Cmw−Cmf) is −5 or more and 6 or less.

4. The rubber composition for a tire according to claim 1, wherein the fatty acid metal salt is an alkali metal salt and/or an alkaline earth metal salt, of fatty acid.

5. The rubber composition for a tire according to claim 1, wherein the petroleum-derived wax is a paraffin type petroleum wax.

6. The rubber composition for a tire according to claim 1, wherein the carbon number (Cmw) of a hydrocarbon contained the most in the petroleum-derived wax is from 20 to 35.

7. The rubber composition for a tire according to claim 1, wherein the amount of the petroleum-derived wax is from 0.1 to 10 parts by mass per 100 parts by mass of the diene rubber, and the amount of the fatty acid metal salt is from 0.5 to 10 parts by mass per 100 parts by mass of the diene rubber.

8. A pneumatic tire having a rubber part comprising the rubber composition according to claim 1, wherein the rubber part is at least one selected from the group consisting of a tread rubber, a side wall rubber, and a rim strip.
